(19) United States
(12) Patent Application Publication
(10) Pub. No.: US 2024/0350858 A1
(43) Pub. Date: Oct. 24, 2024

(54) Body mobilization apparatus

(71) Applicant: LOUISIN RESEARCH AND DEVELOPMENT LIMITED, DUBLIN 2 (IE)

(72) Inventor: GIANFRANCO TUDICO, Tortoreto (IT)

(21) Appl. No.: 18/684,833

(22) PCT Filed: Aug. 19, 2022
(86) PCT No.: PCT/EP2022/073164

§ 371 Date: Feb. 19, 2024

(30) Foreign Application Priority Data
Aug. 20, 2021 (FR) FR2108806

(51) Int. Cl. A63B 21/00; A61G 15/00; A63B 21/005; A63B 26/00; A63B 41/00; A63B 71/06

(52) U.S. Cl. CPC A63B 21/4033; A61G 15/007; A63B 21/00178; A63B 21/0058; A63B 26/003; A63B 41/125; A63B 71/0622; A63B 2208/0233

(57) ABSTRACT

The invention relates to an apparatus (1) which comprises a frame (20) adapted to rest fixedly on the ground and a ball (10) suitable, while a user (U) keeps at least one of their feet on the ground, for supporting the weight of a part of the user's body that is resting on an upper portion (412) of the ball. The apparatus also includes a stabilizing member (30) carried by the frame and designed to retain the ball so as to keep a center of the ball stationary relative to the frame, while allowing the ball to be freely movable with respect to the frame at least following a tilting movement (B) about a horizontal axis (X40) passing through the center of the ball. The apparatus also includes a movable support member (40) which is motorized and adapted to supporting a lower portion (14) of the ball that is pressed downwards against the movable support member under by the user pressing on the upper portion of the ball, and for driving this lower portion at least following the tilting movement.

### CROSS REFERENCES TO RELATED APPLICATIONS

This application is a national phase entry of international application PCT/EP2022/073164, entitled BODY MOBILISATION APPARATUS, filed on Aug. 19, 2022 by applicant Louisin Research and Development Limited, the contents of which are hereby incorporated herein in their entirety.

PCT/EP2022/073164 claims benefit of French Patent Application No. 21 08806, on Aug. 20, 2021, the contents of which are hereby incorporated herein in their entirety.

### FIELD OF THE INVENTION

The present invention relates to a body mobilization apparatus, i.e. an apparatus for moving, in a controlled way, a body part of a human subject using the apparatus.

The invention relates to the field of functional rehabilitation of patients, as well as the physical preparation of healthy subjects.

### BACKGROUND OF THE INVENTION

In this field, one of the basic techniques implemented by physiotherapists is passive mobilization, which is applied, among others, in traumatology, rheumatology, neurology, resuscitation, etc. In such technique, the patient does not exert any voluntary motor action, so the patient's joints are set in motion by the physiotherapist either with or without equipment, such as apparatuses called continuous passive motion machines.

Mobilization is said to be active when the joint movements of the subject are obtained by voluntary muscular contractions of the subject. Active mobilization allows the subject to perform exercises with or without the help of the physiotherapist and with or without stress, depending on the pathology and/or the goal of physical preparation to be achieved. A variety of dedicated material is generally used. Among such material, balls are known, commonly called “Swiss Ball”, “Klein-Vogelbach balls” or “gymball”, which are inflatable spheres having a certain elasticity, on which the subject places a part of their body in order to perform physical exercises, in particular joint exercises. For example, the subject sits on the ball, resting their pelvis directly on a high portion of the ball, while their feet remain in contact with the ground: by seeking to keep their balance, the subject works in particular, the joints and muscles of their lower limbs, pelvis and back. The existing balls are comfortable and come in different diameters, the diameter chosen by the subject depending on the size of the latter and on the part of the body to be rehabilitated or to be worked on. Such balls serve to work on muscle strengthening, the proprioception of deep muscles, coordination, flexibility, core strength, etc. The advantages and virtues of such balls are now well established, so that balls are used both in the medical world and by athletes, especially for muscle building.

However, the existing balls remain equipment which is, by nature, unstable. Using such equipment requires “taming” the precariousness of the stability thereof, which can be difficult or dangerous, or even impossible for some people with reduced mobility or who are frail. Moreover, the features of the existing cannot be easily controlled, such as the amplitude and the speed of the movements of the ball, and hence the effects of mobilization exercises performed with the ball cannot be controlled.

In a distinct field, namely the field of virtual reality equipment, U.S. Pat. No. 6,135,928 discloses equipment permitting natural human locomotion. Such equipment includes a sphere and a frame. The frame is arranged below the ground and supports the sphere so that only a small upper portion of the sphere emerges above the ground, via an opening in the ground. The equipment further includes an aerial support which is held fixedly along the vertical above the sphere by means of a bracket. Such aerial support restrains a user standing on the upper portion of the sphere, by means of a harness. The sphere is dimensioned accordingly, having a diameter comprised between 6 and 7 feet, i.e. between 180 and 215 cm. The sphere is allowed to rotate freely around the center thereof with respect to the frame, allowing the user to walk or run on the upper part of the sphere, by rotating the ball around the center thereof whereas the user stands still with respect to the frame. To this end, the equipment includes, at the interface between the frame and the sphere, both “idle” castors, which are distributed over the entire surface of the sphere, located below the ground, and that allow the sphere to rotate about the center thereof in any direction, and wheels with a fixed horizontal axis, which are located at the equator of the sphere and are used to reduce the slipping of the sphere and the involuntary rotation thereof about a vertical axis passing through the center of the sphere. The equipment is designed to work without the use of a motor. That being said, U.S. Pat. No. 6,135,928 mentions the possibility of motorizing the wheels with a fixed horizontal axis in order to be able to “accelerate” the rotation of the sphere and thus force the user to “walk faster”. In such case, U.S. Pat. No. 6,135,928 specifies that the wheels with a fixed horizontal axis should be in close contact with the outer face of the sphere, which is equivalent to saying that the wheels with a fixed horizontal axis are pressed horizontally against the sphere.

### SUMMARY

The goal of the invention is to propose a new body mobilization apparatus which, while using a ball similar to the balls mentioned hereinabove, is easy and safe to use and serves to carry out effective and controlled body mobilization exercises, where appropriate under passive mobilization.

To this end, the subject matter of the invention is a body mobilization apparatus comprising:
a frame adapted to rest fixedly on the ground,
a ball adapted to support the weight of a body part of a user when said body part is pressed on an upper portion of the ball while the user keeps at least one of their feet on the ground,
a stabilizing member, which is carried by the frame and which is designed to retain the ball by contact so as to keep a center of the ball substantially stationary with respect to the frame, while leaving the ball freely movable with respect to the frame at least in a first tilting movement about a first horizontal axis passing through the center of the ball, and
a movable support member, which is motorized and which is adapted to support a lower portion of the ball, pressed downwards against the movable support member under effect of pressing from the user on the upper portion of the ball, and to drive the lower portion of the ball at least in the first tilting movement with respect to the frame.

One of the ideas underlying the invention is to use an existing ball of the type mentioned hereinabove, but by seeking both to stabilize the position of the ball with respect to the ground, in particular to prevent the ball from rolling on the ground, and to rotate the ball on itself in a motorized and hence controlled way. To this end, the invention provides that the ball is retained by contact with a dedicated member of the apparatus, called a stabilizing member, which, while maintaining the center of the ball fixed with respect to a fixed frame of the apparatus, allows the ball to at least tilt on itself about a horizontal axis passing through the center of the ball, or even rotate on itself about the center thereof, with respect to the frame. The user who rests a part of their body on an upper portion of the ball, while keeping at least one foot on the ground, thereby does not run the risk of being substantially destabilized. For example, the user can sit on the ball, keeping both feet on the ground, or stand with one foot on the ground and the other foot on the upper portion of the ball. Moreover, the invention provides that the ball is at least tilted about the above-mentioned horizontal axis, or even rotated about the center thereof, with respect to the frame by a dedicated motorized member of the apparatus, called a movable support member, on which a lower portion of the ball rests. When the user rests the weight of a part of their body on the upper portion of the ball, the lower portion of the ball is pressed against the movable support member, the motor activation of which drives, in a corresponding way, the lower portion of the ball into controlled movements. More particularly, the motorized movements may e.g. have a small angular amplitude and a rapid motion, or else have a greater angular amplitude and a slower speed. The user passively accompanies the motorized movements of the ball or, on the contrary, attempts to resist the motorized movements of the ball. In both cases, the motorized movements are carried out either in a preprogrammed way or in a random way. The invention is also available in a version where the ball is not spherical, but elongated, in particular having a peanut-shape, centered on the aforementioned horizontal axis. In practice, as discussed in detail thereafter, the stabilizing member and the movable support member may have multiple embodiments which are covered by the invention. In all cases, the apparatus according to the invention serves to carry out functional rehabilitation exercises, typically under the supervision of a physiotherapist, but, more generally, serves to carry out physical preparation exercises in the field of sport and fitness, as discussed in detail hereinafter. The health professional or sports practitioner may in particular use the apparatus according to the invention to make the user work according to precise movements following biomechanics, which are controlled with regard to the characteristics thereof, such as time, speed, amplitude, repetition, etc. The user of the apparatus according to the invention thereby works in a safe, efficient and playful way.

According to advantageous features of the apparatus according to the invention:
The ball has an overall spherical shape centered on said center; the stabilizing member is adapted, while maintaining the center of the ball substantially stationary with respect to the frame, to allow the ball to rotate freely about the center of the ball with respect to the frame; and the movable support member is adapted to drive the lower portion of the ball in rotation about the center of the ball with respect to the frame.
The movable support member is adapted to drive the lower portion of the ball with respect to the frame exclusively in the first tilting movement.
The movable support member is adapted, in addition to driving the lower portion of the ball with respect to the frame in the first tilting movement, to drive the lower portion of the ball with respect to the frame in a second tilting movement about a second horizontal axis, which passes through the center of the ball and which is distinct from the first horizontal axis.
The second horizontal axis is perpendicular to the first horizontal axis.
The ball has an elongated shape, which extends lengthwise along the first horizontal axis and which, in cross-section perpendicular to the first horizontal axis, has a circular contour that is centered on the first horizontal axis.
Said circular contour has a diameter which varies in value through the ball along the first horizontal axis, the diameter having a first value in a median portion of the ball and having a second value in each of two end portions of the ball, which are arranged on both sides of the median portion of the ball along the first horizontal axis, the first value being less than the second value.
The movable support member includes:
   a drive unit,
   a stationary part that is rigidly attached to the frame, and
   a movable part, on which the lower portion of the ball rests and which is mounted so as to be movable, in particular in translation or in rotation, on the stationary part and to be driven in motion by the drive unit.
In use, the stabilizing member is fixedly integrated into the frame and in sliding contact with the ball.
In use, the stabilizing member is freely movable with respect to the frame and is driven by contact by the ball.
The stabilizing member is arranged laterally to the ball and is in contact with an intermediate portion of the ball over a continuous zone of the stabilizing member, which, in projection in a horizontal plane, extends over more than 180°, or even 360°, around the ball.
The stabilizing member is arranged laterally to the ball and is in contact with an intermediate portion of the ball over a plurality of distinct zones of the stabilizing member, which, in projection in a horizontal plane, are dimensioned and distributed around the ball so as to maintain the center of the ball substantially stationary with respect to the frame.
The stabilizing member is arranged below and is in matching contact with the lower portion of the ball.
   The apparatus includes a control unit adapted to control in motion the movable support member, and an interface adapted to activate and set the control unit and to display values relating to operation of the body mobilization apparatus.

### BRIEF DESCRIPTION OF THE DRAWINGS

The invention will be better understood upon reading the following description, given only as an example and making reference to the drawings, wherein:

FIG. 1 is a perspective schematic representation of an apparatus according to a first embodiment of the invention;

FIG. 2 is a schematic section along the plane II-II shown in FIG. 1;

FIG. 3 is a schematic section along the line III-III shown in FIG. 2;

FIG. 4 is a perspective schematic representation of an embodiment for a movable support member belonging to the apparatus shown in the preceding figures;

FIG. 5 is a view similar to FIG. 3, showing a configuration of use different from the configuration shown in FIGS. 1 to 3;

FIG. 6 is a schematic section in the same plane as in FIG. 3, illustrating another embodiment of the movable support member;

FIG. 7 is a view similar to FIG. 2, showing an alternative embodiment for a stabilizing member belonging to the apparatus shown in the preceding figures;

FIG. 8 is also a view similar to FIG. 2, schematically illustrating another alternative embodiment for the movable support member of the apparatus shown in the preceding figures;

FIG. 9 is a section similar to FIG. 3, illustrating a second embodiment according to the invention;

FIG. 10 is a schematic view, in elevation, according to the arrow X shown in FIG. 9, of a part of the apparatus shown in FIG. 9; and

FIGS. 11 and 12 are views similar to FIGS. 1 and 2, respectively, which illustrate a third embodiment of the apparatus, according to the invention.

### DETAILED DESCRIPTION

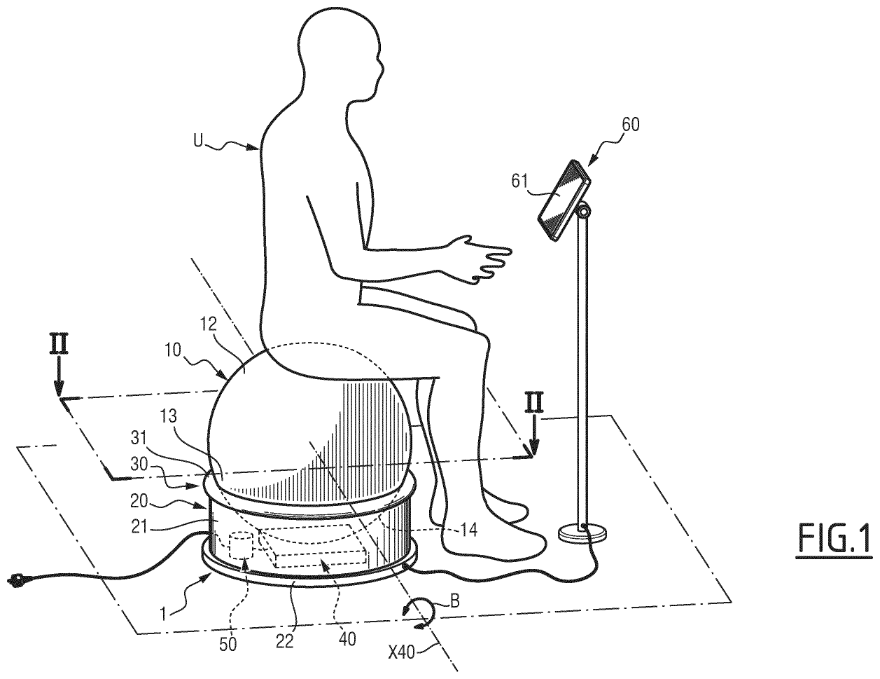

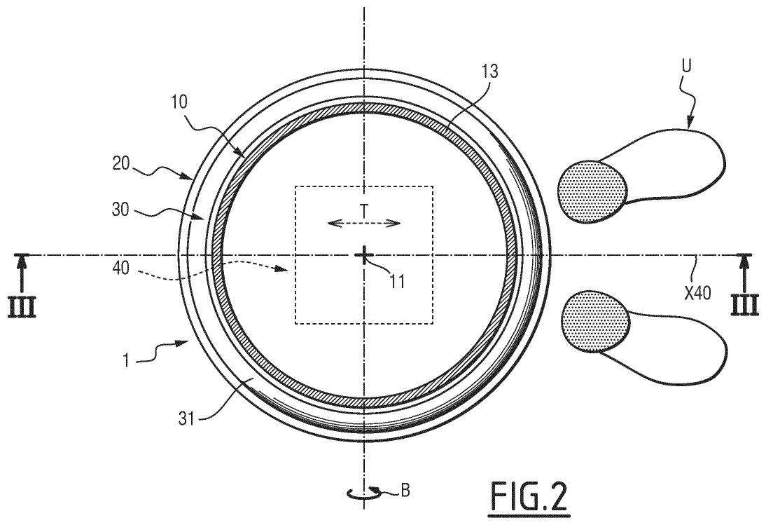

FIGS. 1 to 3 show a body mobilization apparatus 1 designed to set in motion the body of a user U.

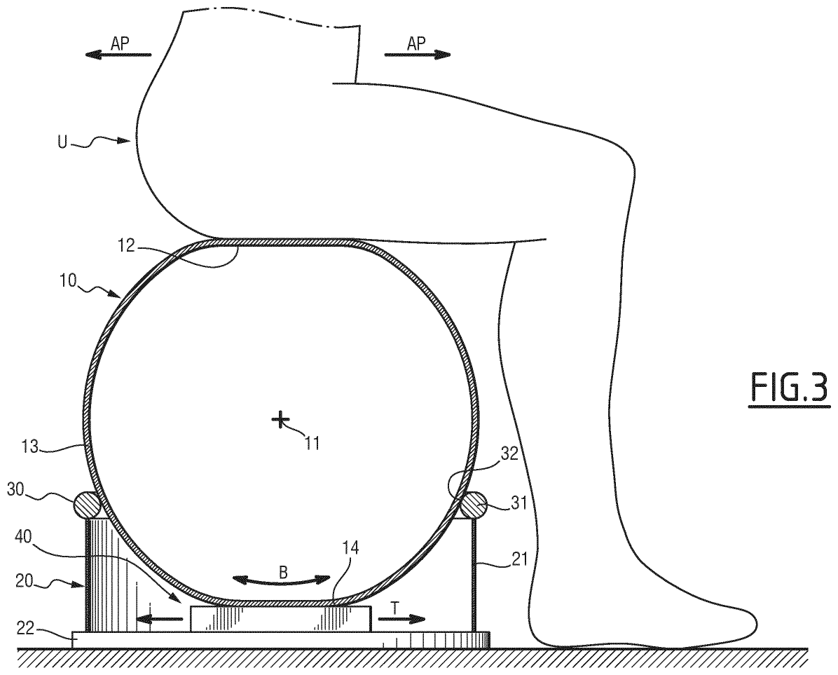

The apparatus 1 includes a ball 10 having a spherical shape the center of which has the reference 11. In practice, the ball 10 consists of a flexible envelope, in particular an elastic envelope, which is designed to be inflatable and which, in the inflated state, gives the ball 10 the spherical shape thereof. The specificities of the ball 10 are not limiting to the invention, provided that the ball can support the weight of a part of the body of the user U, abutting on an upper portion 12 of the ball, i.e. a portion which, when the apparatus 1 is used, is oriented upwards. For example, in FIG. 1, the user is seated on the upper portion 12 of the ball 10, resting on the upper portion 12 with their pelvis, whereas the user's two feet are directly supported on the ground. The ball 10 has a diameter comprised e.g. between 50 and 90 cm. Given the flexibility of the wall of the ball 10, the upper portion 12 tends to be slightly crushed under the effect of the weight of the user U, as shown diagrammatically in FIG. 3, it being noted, however, that the ball 10 is designed to keep the overall spherical shape thereof, more particularly in the intermediate portion 13 thereof connecting the upper portion 12 to a lower portion 14 of the ball.

The ball 10 thereby typically corresponds to the balls mentioned in the introductory part of the present document, i.e. the balls intended for physical activity and available commercially under the names of “Klein-Vogelbach balls”, “gymball” or “Swiss Ball”.

As can be seen clearly in FIGS. 1 to 3, the apparatus 1 further includes a frame 20 by which the apparatus 1 rests fixedly on the ground. In the embodiment considered in FIGS. 1 to 3, the frame 20 mainly comprises a tubular box 21 centered on a geometric axis which, when the apparatus 1 is used, extends vertically, i.e. perpendicularly to the ground. In practice, the specificities of the frame 20 are not limiting as long as the frame provides, in service, a fixed support of the apparatus 1 on the ground. Thereby, as an advantageous arrangement, the frame 20 comprises an underframe 22.

When the apparatus 1 is used, the ball 10 is not directly attached to the frame 20, but through the interposition of a stabilizing member 30. The stabilizing member 30 is supported by the frame 20 and is designed to retain the ball 10 by contact so as to at the same time, keep the center 11 of the ball 10 stationary with respect to the frame 20 and allow the ball 10 to rotate freely about the center 11 thereof, with respect to the frame 20. In practice, the stabilizing member 30 has many possible embodiments.

In the embodiment considered in FIGS. 1 to 3, the stabilizing member 30 includes a part 31 which, in service, is fixedly integrated into the frame 10 and is in sliding contact with the ball 10. The part 31 has herein the shape of an open torus, arranged coaxially with the tubular box 21 of the frame 20, being situated at the end of the tubular box 21, which is axially opposite the ground. The toroidal shape of the part 31 is exploited to arrange the stabilizing member 30 laterally of the ball 10 and to bring the stabilizing member 30 into contact with the intermediate portion 13 of the ball 10 over a zone 32 of the part 31, which runs continuously all around the intermediate portion 13 of the ball 10. Thereby, in projection in a horizontal plane, i.e. parallel to the ground, the zone 32 of the stabilizing member 30, which is in contact with the intermediate portion 13 of the ball 10, extends continuously over 360 degrees around the ball, which physically retains the ball 10 with respect to the frame 20 in all horizontal directions. The above is equivalent to saying that the zone 32 of the stabilizing member 30 prevents, by interference of contact with the intermediate portion 13 of the ball 10, the position of the center 11 of the ball 10 from being modified with respect to the frame 20. Of course, the center 11 of the ball 10 is thereby immobilized with respect to the frame 20 within functional clearances, relating more particularly to the inherent flexibility of the wall of the ball 10. In a variant (not shown), the zone 32 extends continuously over a lesser angular extent around the intermediate portion 13 of the ball 10, provided that said zone of the stabilizing member 30 extends continuously, in a projection in a horizontal plane, over more than 180° around the ball 10.

Moreover, the sliding contact provided between the zone 32 of the stabilizing member 30 and the intermediate portion 13 of the ball 10 allows the ball 10 to rotate freely about the center 11 thereof with respect to the frame 20: the sliding contact results, in particular, from ad hoc features of the part 31, in particular the geometrical profile thereof, the constituent material thereof, etc.

Whatever the embodiment of the stabilizing member 30, the apparatus 1 is designed to rotate the ball 10, in a motorized way, about the center 11 thereof, with respect to the frame 20. To this end, the apparatus 1 comprises a movable support member 40 which is shown only schematically in FIGS. 1 to 3 and of which many embodiments can be envisaged. Whatever the embodiment thereof, the movable support member 40 is motorized and is adapted to supporting and rotating about the center 11, the lower portion 14 of the ball 10, which, in service, is pressed against the movable support member 40, as clearly visible in FIG. 3. Thereby, when the apparatus 1 is used, the lower portion 14 of the ball 10 is pressed downwards against the movable support member 40 under the effect of the user U pressing against the upper portion 12 of the ball 10, the lower portion 14 tending to slightly deform flexibly by crushing for reasons similar to the reasons indicated hereinabove with regard to the crushing of the upper portion 12 of the ball 10. In practice, the pressing of the lower portion 14 of the ball 10 on the movable bearing member 40 serves to transmit a movement from the movable member 40 to the lower portion 14 of the ball 10 and, thereby, to the entire ball 10.

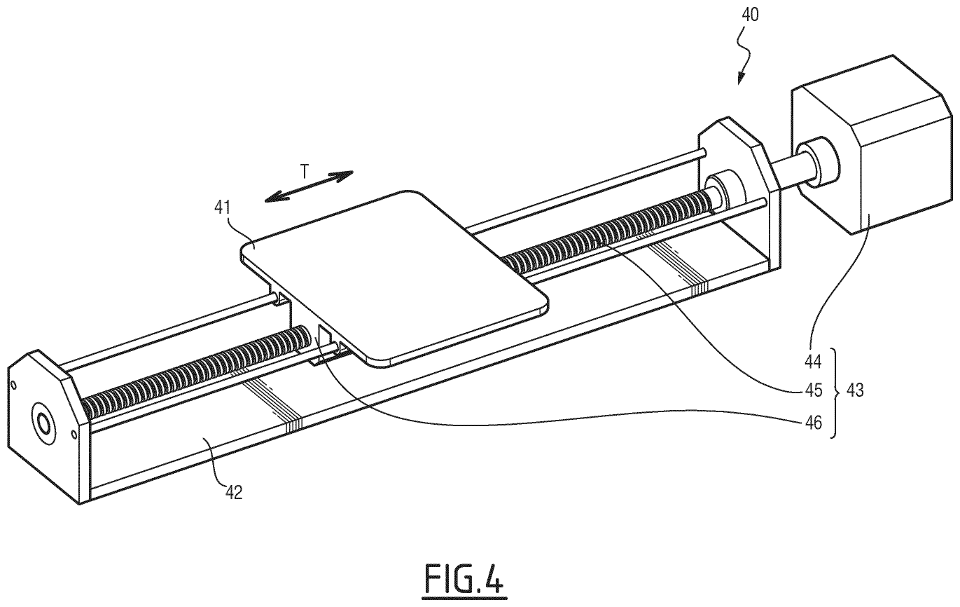

According to one embodiment of the movable support member 40, which is illustrated in FIG. 4, the movable support member 40 comprises a plate 41, on which the lower portion 14 of the ball 10 rests and which is mounted movably on a base 42 of the movable support member 40, by being guided, herein exclusively, according to a rectilinear translation movement T with respect to the base 42, and by any appropriate guide means. The base 42 is fixedly rigidly attached to the frame 20 and thereby forms a fixed part for the movable support member 40, compared to the plate 41 which forms a movable part thereof. In addition, the movable support member 40 includes a drive unit 43 controlling the translation movement T of the plate 41 with respect to the base 42: in the example considered in FIG. 4, the drive unit 43 comprises an electric motor 44 the output of which rotates a worm screw 45 which is supported by the base 42 with the interposition of bearings and which is screwed into a nut 46 rigidly attached to the plate 41. By actuating the electric motor 44, the screw 45 is screwed/unscrewed in the nut 46 while the latter is locked in rotation, which translates the nut 46 and, thereby, the plate 41 along the rectilinear translation T. More generally, it should be understood that the movable support member 40 illustrated in FIG. 4 corresponds to a motorized actuator with a linear translational output.

The translational movement T of the movable support member 40 is transmitted to the lower portion 14 of the ball 10, being converted by the presence of the stabilizing member 30, in a tilting movement B of the ball 10, about a horizontal axis X40 passing through the center 11 of the ball. The tilting movement B, which is herein the only movement with which the lower portion 14 of the ball 14 is driven by the movable support member 40, is oriented in a way corresponding to the direction of the translational movement T, in the two possible opposite directions, as illustrated schematically in FIG. 3.

Whatever the embodiment of the movable support member 40, the latter is advantageously controlled in motion by a control unit 50 belonging to the apparatus 1. The control unit 50 is shown schematically only in FIG. 1, being housed inside the frame 20 without such arrangement being limiting. The control unit 50 serves to control the actuation of the movable support member 40. Applied to the example of embodiment shown in FIG. 4, the above is equivalent to saying that the control unit 50 controls the electric motor 44 so as to control the kinematic characteristics of the translational movement T and, thereby, same of the tilting movement B. In practice, the control unit 50 is typically an electronic device, e.g. including a microprocessor. More generally, the control unit 50 is connected, in a wired or non-wired manner, to the movable support member 40 for the purpose of controlling the latter, in particular with regard to supplying same with energy, typically with electricity.

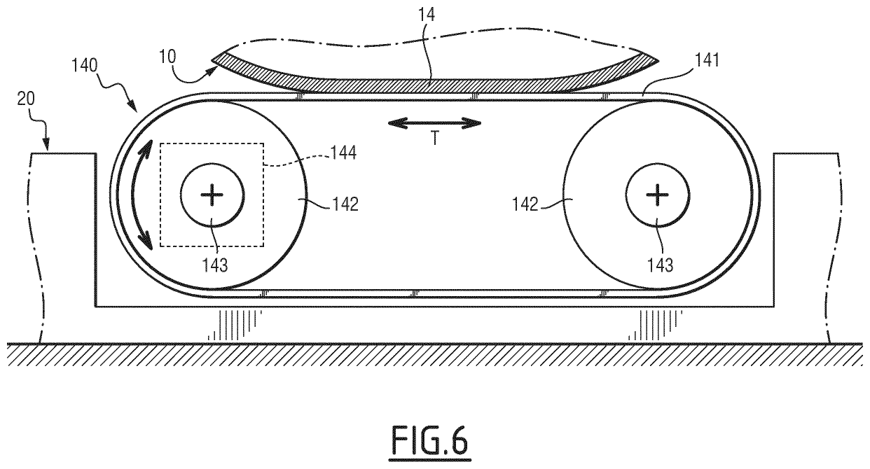

Before turning to the alternative embodiments illustrated in FIGS. 6 et seq., examples of the use of the apparatus 1 described hitherto will now be presented in greater detail. Thereby, according to the example of use illustrated in FIG. 1, where the user U sits on the ball 10 as described hereinabove, the actuation of the movable support member 40 by the control unit 50 tilts the ball 10 according to the tilting movement B centered on the horizontal axis X40. The tilting movement B is advantageously controlled to and fro with respect to an initial position of the ball 10 about the horizontal axis X40, with an angular amplitude which is controlled by the control unit 50. The user U can then either work passively, accompanying the tilting movement B of the ball, or work resisting the tilting movement B. In both cases, the user U mobilizes the joints and muscles of their lower limbs, of their pelvis and their back so as to keep their balance in the sitting position on the upper portion 12 of the ball 10. The user U works in this way in a secure manner since the ball 10, even when tilted by the tilting movement B, is retained by the stabilizing member 30, as explained hereinabove.

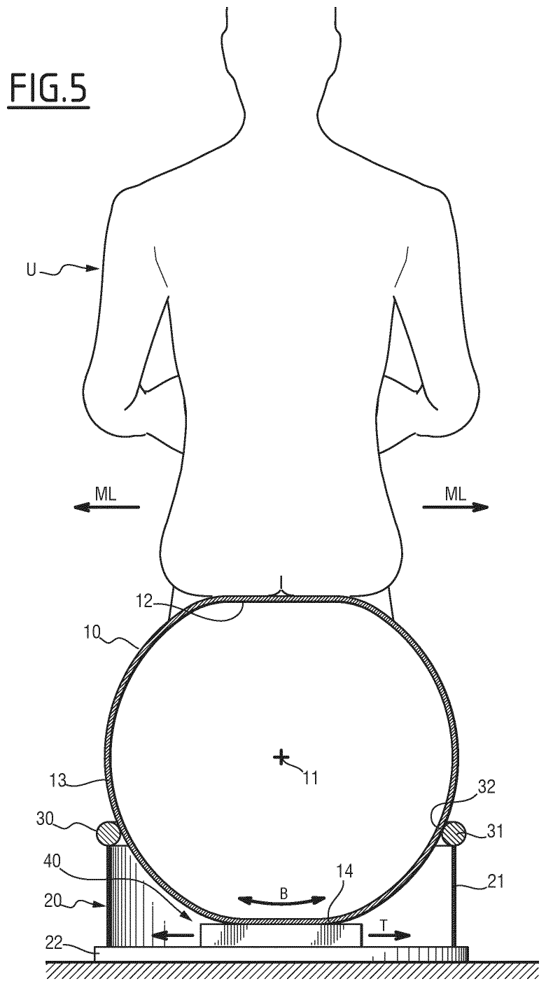

It should be noted that when the user U is seated on the ball 10 so that the horizontal axis X40 extends substantially perpendicular to the sagittal plane of the user U, as illustrated in FIGS. 1 to 3, the joint and muscular mobilization of the user U is oriented in an antero-posterior direction with respect to the user, as indicated by the arrows AP in FIG. 3. However, such joint and muscular mobilization can be oriented differently, in particular with a left-right component, depending on the angulation between the horizontal axis X40 and the sagittal plane of the user U. Thereby, as an example, FIG. 5 illustrates the situation where the user U is sitting on the ball 10 so that the horizontal axis X40 extends substantially in the sagittal plane of the user U, the latter being seen from the back in FIG. 5: the joint and muscular mobilization of the user U is then oriented in a medio-lateral direction with respect to the user, as indicated by the arrows M1 in FIG. 5. The situations illustrated in FIGS. 3 and 5, respectively, wherein the user U occupies two different seated positions, respectively, which are at 90° from each other, are two configurations of use which are not limiting, but which are preferential in the sense that the latter can permit a mobilization exclusively along the antero-posterior direction and a mobilization exclusively along the medio-lateral direction, respectively. In practice, to facilitate the identification of the two configurations of use, the frame 20 is advantageously provided with markings or visual indicators, which are associated with the two configurations of use, respectively, and which allow the user U to easily position themselves in relation to the frame and thereby to place themselves on the ball 10 in the chosen sitting position. In all cases, the angular amplitude of the tilting of the ball 10 with respect to the aforementioned initial position, as well as the speed of the tilting and the number of reciprocations can be adjusted by means of the control unit 50, e.g. by defining one or a plurality of pre-programmed sequences or, on the contrary, by authorizing random sequences.

It will also be noted that the user U can use the apparatus 1 in positions other than the sitting position. More particularly, according to a possibility not shown, the user U stands, with one of their feet pressed downwards on the upper portion 12 of the ball 10 so that the ball supports the weight of a part of the body of the user U, while their other foot remains directly on the ground. More generally, the apparatus 1 can be used, for the purpose of a body mobilization of the user U, in multiple positions of the user, enabling the latter to support the weight of at least a part of their body on the upper portion 12 of the ball 10.

Taking into account the explanations given hitherto, it should be understood that, in the field of physiotherapy, the apparatus 1 serves to perform functional rehabilitation on the user U, in passive mobilization or with resistance, along with control of the body mobilization of the user. In the field of sport and fitness, the apparatus 1 allows the U user to work on their flexibility and muscular strength, to perform stretching, to improve their balance and to perform postural gymnastics. In all cases, the body mobilization applied to the user U by the apparatus 1 is done in a simple way and is effective, without apprehension on the part of the user, even if the latter is in a situation of reduced mobility or of cognitive frailty.

According to an advantageous optional arrangement, which is illustrated schematically in the embodiment considered in FIG. 1, the apparatus 1 is equipped with an interface 60 which is connected to the control unit 50 for the purpose of activating and setting the latter. The interface 60 comprises control elements which are associated with the activation and setting parameters respectively, of the control unit 50 and which can be actuated manually. According to an advantageous embodiment, the interface 60 comprises a display screen 61 which integrates the aforementioned control elements and which, in addition, serves to display to the user U, values relating to the operation of the apparatus 1, such as the duration of the exercise in progress, the kinematic characteristics of the movements applied to the ball 10 by the movable support member 40, the detail of the sequence or sequences in progress, etc. The display screen 61 thereby provides feedback to the user U, enabling the latter to follow and control the body mobilization applied to them by the apparatus 1.

Hereinafter, we will focus more on FIGS. 6 et seq. for mentioning alternative embodiments to the arrangements of the apparatus 1 described hitherto.

As mentioned hereinabove, the movable support member 40 of the apparatus 1 may have embodiments other than the embodiment illustrated in FIG. 4. Thereby, FIG. 6 shows, as an alternative to the movable support member 40, a movable support member 140, which is functionally similar to the movable support member 40, but which is structurally different. More precisely, the movable support member 140 comprises a revolving belt 141 on which the lower part 14 of the ball 10 rests. The movable support member 40 further comprises rollers 142, around which the revolving belt 141 is mounted by being connected in motion to the rollers 142, as well as support shafts 143 on which the rollers 142 are correspondingly mounted to rotate about the central axis thereof. The support shafts 143 are rigidly attached to the frame 20. The movable support member 140 further includes a drive unit 144, typically electrically motorized, which serves to rotate at least one of the rollers 142 and, thereby, to control the movement of the conveyor belt 141 in a rectilinear translational movement, which is similar to the translational movement T described with reference to FIG. 4 and which, for convenience, has also the reference T in FIG. 6. Thereby, the conveyor belt 141 and the rollers 142 together form a movable part for the movable support member 140 which, with respect to the fixed part formed by the support shafts 143 and with respect to the drive unit 144, is functionally similar to the plate 41 of the movable support member 40, with respect to the base 42 and to the drive unit 43 of the movable support member 40.

The movable support member 40 and 140, respectively illustrated in FIGS. 4 and 6, are not limiting but, on the contrary, illustrate the multiple possibilities of embodiment that the movable support member belonging to the apparatus 1 can take, in order to support the lower part 14 of the ball 10 and to drive this lower part of the ball in rotation about the center 11 of the ball 10 with respect to the frame 20, in particular according to the tilting movement B about the horizontal axis X40, or even exclusively according to this tilting movement B.

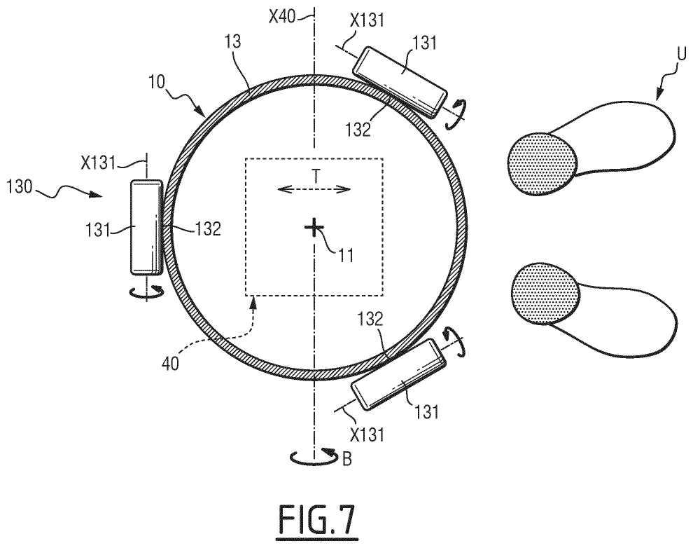

As mentioned hereinabove, the stabilizing member 30 of the apparatus 1 may have embodiments other than the embodiment illustrated in FIGS. 1 to 4. Thereby, FIG. 7 shows, as an alternative to the stabilizing member 30, a stabilizing member 130, which is functionally similar to the stabilizing member 30, but which differs structurally therefrom in several respects.

More precisely, the stabilizing member 130 comprises three rollers 131 correspondingly centered on axes X131. The rollers 131 are arranged laterally to the ball 10, being in contact with the intermediate portion 13 of the ball 10 over three respective distinct zones 132 of the rollers 131. According to a practical and effective arrangement, the respective axes X131 of the rollers 131 extend both horizontally and substantially parallel to tangents to the intermediate portion 13 of the ball 10. Thereby, the three zones 132 where the rollers 131 are in contact with the intermediate portion 13 of the ball 10 are point-like, or almost point-like, taking into account the capacity of deformation of the wall of the ball 10. In all cases, the zones 132 of the rollers 131 are, in projection, in a horizontal plane, regularly distributed around the intermediate portion 13 of the ball 10 so as to constrain the center 11 of the ball 10 fixedly in position. It should be understood that, in variants not shown, the rollers 131 may be provided in a number different from three and may be made in various forms of individual bearing elements belonging to the stabilizing member, as long as respective distinct zones of the support elements are in contact with the intermediate portion 13 of the ball 10, being, in projection in a horizontal plane, dimensioned and distributed around the ball so as to keep the center 11 of the ball substantially stationary with respect to the frame 20.

Moreover, independently of the arrangement detailed hereinabove for the rollers 131 around the ball 10, each of the rollers 131 is provided, when the apparatus 1 is used, freely rotatable about the axis X131 thereof. Thereby, unlike the part 31 of the stabilizing member 130, provided in sliding contact with the ball 10, the rollers 131 are, in service, freely movable with respect to the frame 20, namely, herein, freely rotatable about the axis X131 thereof. When the ball 10 is rotated about the center 11 thereof with respect to the frame 20, the rollers 131 are driven by contact, by the ball, about the axis X131 thereof.

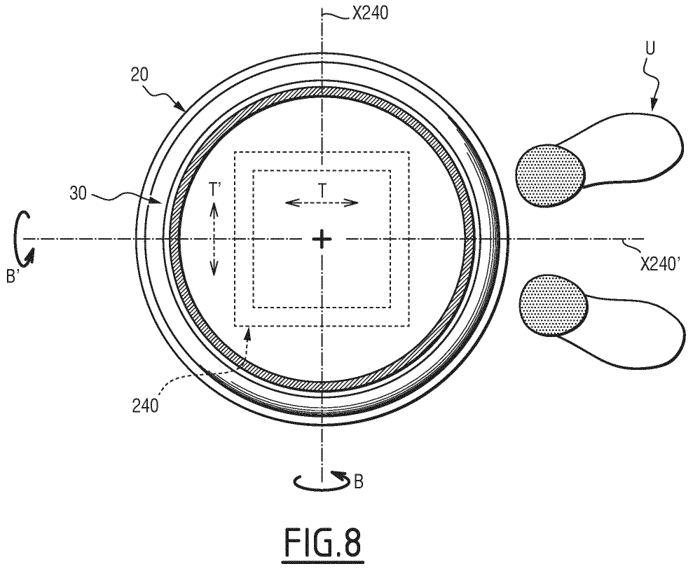

FIG. 8 shows, as an alternative embodiment to the movable support members 40 and 140 for the apparatus 1, a movable support member 240. In a similar way to the movable support members 40 and 140, the movable support member 240 serves, in particular from the translational movement T, to tilt the lower portion 14 of the ball 10 with respect to the frame 20 in the tilting movement B about a horizontal axis 240 similar to the horizontal axis X40. Furthermore, the movable support member 240 serves to tilt the lower portion 14 of the ball 10 in a movement other than the tilting movement B, namely a tilting movement B′ about a horizontal axis X240′, which passes through the center 11 of the ball 10 but which is distinct from the horizontal axis X240. The horizontal axes X240 and X240′ are preferentially perpendicular to each other, as in the example considered in FIG. 8. In practice, the tilting of the ball 10 according to the tilting movement B′ by the movable support member 240 can be obtained from a translational movement T′ of the movable support member 240 with respect to the frame 20, in particular by integrating into the movable support member 240, arrangements similar to the arrangements described hereinabove for the movable support members 40 and 140 in connection with the translational movement T. For example, the movable support member 240 comprises two motorized actuators with linear translational output, which are individually similar to the linear actuator shown in FIG. 4 but are arranged “in series” with each other.

Whatever the embodiment of the movable support member 240, the latter serves, in service, to rotate the ball 10 about the center 11 thereof, with respect to the frame 20 in two different distinct movements, namely the tilting movements B and B′. The respective kinematic characteristics of these two different movements are advantageously controlled by the control unit 50, adapted accordingly to control the motion of the movable support member 240.

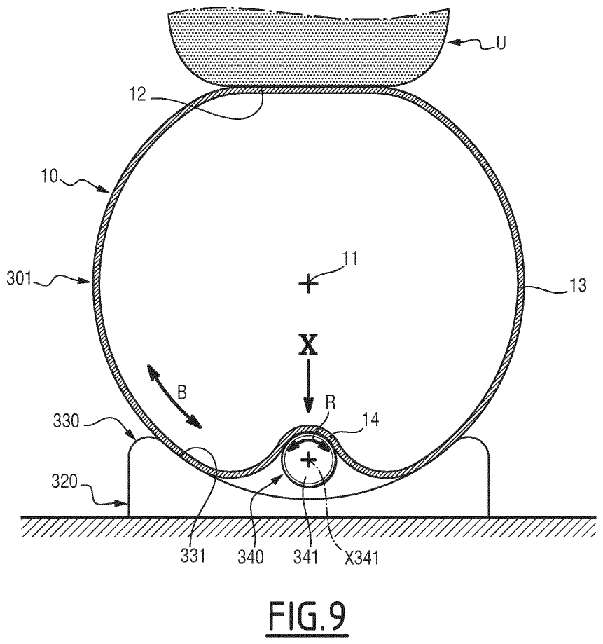

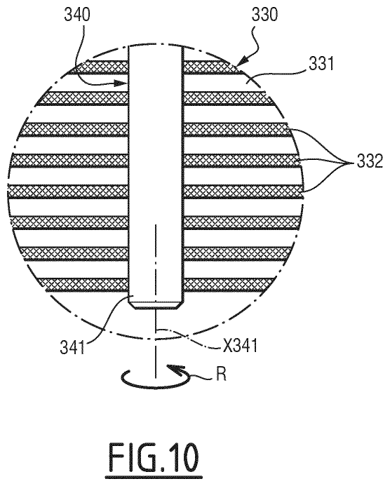

FIGS. 9 and 10 show a body mobilization apparatus 301 as an alternative embodiment to the apparatus 1 considered hitherto.

The apparatus 301 comprises the ball 10 described hereinabove, as well as a frame 320, a stabilizing member 330 and a movable support member 340, which are functionally similar to the frame 20, the stabilizing member 30 or 130, and the movable support member 40 or 140, respectively, of the apparatus 1, but which are structurally different from the latter.

More particularly, the stabilizing member 330 is arranged below the lower portion 14 of the ball 10 and forms a bowl 331 which is fixedly integrated into the frame 320 and at the hollow of which the lower portion 14 of the ball 10 is brought into matching contact. The bowl 331 serves, in particular by the match thereof with the lower portion 14 of the ball 10, to retain the ball by contact, while keeping the center 11 of the ball 10 substantially stationary with respect to the frame 320, while leaving the ball 10 freely rotatable about the center 11 thereof with respect to the frame. To this end, the bowl 311 is provided in sliding contact with the ball 10, the upper face of the bowl 311 being advantageously covered with sliding contact strips 332, as shown schematically in FIG. 10.

The movable support member 340 is made in the form of a motorized roller 341 centered on a horizontal axis X341. The motorized roller 341 includes a motorization, which is typically electrical and which is advantageously integrated inside the motorized roller. Such motorization is apt to rotate the motorized roller 341 about the axis X341 thereof, with respect to a fixed support of the motorized roller, the support being rigidly attached to the frame 320. The corresponding rotational movement of the motorized roller 341, which has the reference R in FIGS. 9 and 10, is transmitted to the lower part 14 of the ball 10, which is pressed against the motorized roller 341, by means of the flexible deformation of the lower portion 14 of the ball 10, as indicated schematically in FIG. 9. The motorized roller 341 thereby supports the lower portion 14 of the ball 10 and, when rotated according to the movement R, same rotates the lower portion of the ball about the center 11 of the ball with respect to the frame 320, in particular or even exclusively in a tilting movement, which is similar to the tilting movement B presented hereinabove and which, for convenience, also has the reference B in FIG. 9.

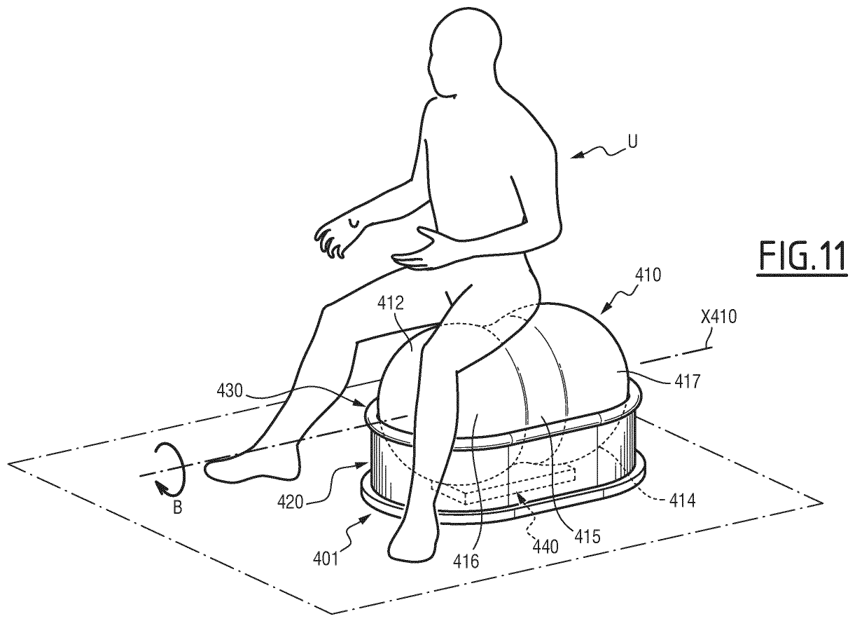

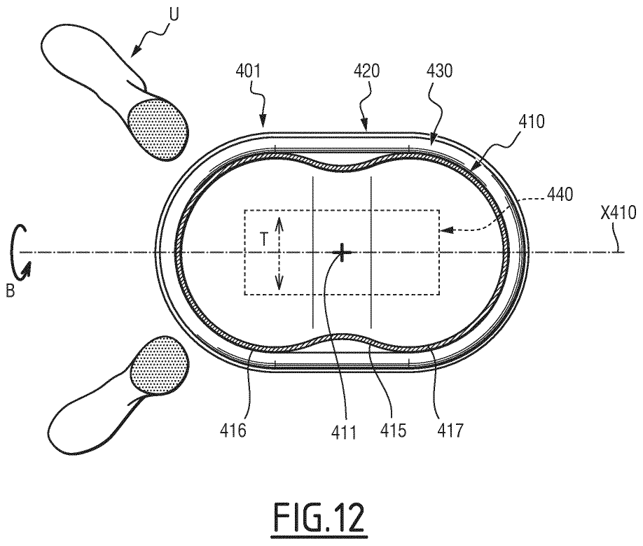

FIGS. 11 and 12 show a body mobilization apparatus 401, as an alternative embodiment to the apparatuses 1 and 301 considered hitherto.

The apparatus 401 comprises a ball 410 which, like the ball 10, consists of an inflated flexible envelope but which, unlike the ball 10, is not spherical but has an elongated shape. The elongated shape of the ball 410 is centered on an axis X410, along which the elongated shape extends in length and which, when the apparatus 401 is used, extends horizontally. The ball 410 thereby has a center 411 through which the horizontal axis X410 passes, and which is situated substantially halfway between the opposite longitudinal ends of the ball 410. In section perpendicular to the horizontal axis 410, the elongated shape of the ball 410 has a contour, i.e. an external profile, which is circular and centered on the horizontal axis X410. The circular contour is found substantially at any point on the horizontal axis X410 along the ball 410 between the opposite longitudinal ends thereof, except. where appropriate, locally at the longitudinal ends. In practice, according to considerations similar to the considerations developed hereinabove for the ball 10, an upper portion 412 of the ball 410, on which the user U rests, in use, the weight of at least part of their body, as well as a lower portion 414 of the ball 410, vertically opposite the upper portion 412 thereof, tends, in service, to deform slightly by crushing.

In the embodiment considered in FIGS. 11 and 12, the diameter of the contour of the elongated shape of the ball 410 is not constant in the running part of the ball, connecting the opposite longitudinal ends of the ball to each other. The ball 410 thereby advantageously includes a median part 415, at which the center 411 is situated along the horizontal axis X410, and two end parts 416 and 417, which are arranged on both sides of the median part 415 along the horizontal axis X410. In the median part 415, the contour of the elongated shape of the ball 410 has a diameter the value of which is smaller than the diameter of the contour in the end parts 416 and 417: as a result therefrom, the ball 410 has an overall peanut shape.

The apparatus 401 further comprises a frame 420 which is functionally similar to the frame 20 of the apparatus 1, but which is structurally different from the latter in the sense that the frame 420 fits the elongated shape of the ball 410.

The apparatus 401 further comprises a stabilizing member 430. In a similar way to the stabilizing member 30 of the apparatus 1, the stabilizing member 430 is supported by the frame 420, being interposed in service between the latter and the ball 410 and serves to retain the ball 410 by contact. More precisely, as for the stabilizing member 30, the stabilizing member 430 holds the center 411 of the ball 410 substantially stationary with respect to the frame 420, while leaving the ball a freedom of movement with respect to the frame 420. The freedom of movement is, however, less than the freedom left by the stabilizing member 30, in the sense that, given the elongated shape of the ball 410, the stabilizing member 430 essentially leaves the ball freely movable with respect to the frame 420, even exclusively in a tilting movement about the horizontal axis X410. The tilting movement is similar to the tilting movement B described hereinabove so that, for convenience, same also has the reference B in FIGS. 11 and 12. In practice, the specifications for the embodiment of the stabilizing member 430 are not limiting and the various considerations hereinabove developed concerning the many possible embodiments of the stabilizing member 30 apply, mutatis mutandis, to the stabilizing member 430.

The apparatus 401 further comprises a movable support member 440 which is functionally similar to the movable support member 40 or 140 of the apparatus 1. The movable support member 410 is designed in particular to support the lower portion 414 of the ball 410, pressed, more particularly at the end parts 416 and 417, against said ball under the effect of the user U pressing on the upper portion 412 of the ball, and in order to tilt the lower portion 414 and, thereby, the entire ball 410 in the tilting movement B, in particular from a translational movement which is similar to the translational movement T described hereinabove for the movable support members 40 and 140. In practice, the movable support member 440 is e.g. structurally similar to the movable support members 40 and 140 discussed in detail hereinabove.

The use of the apparatus 401 is similar to the use of the apparatus 1. As an example illustrated in FIGS. 11 and 12, the user U is seated on the ball 410, more precisely on the median part 415 of the latter, thereby benefiting from an antero-posterior wedging effect of the user's pelvis by the end parts 416 and 417 of the ball, so that the horizontal axis X410 extends substantially in the sagittal plane of the user: through the driving of the ball by the movable support member 440 and the restraint thereof guided by the stabilizing member 430, the ball 410 is moved according to the tilting movement B, which induces a joint and muscular mobilization of the user U oriented along a medio-lateral direction with respect to the user. Of course, taking into account the preceding explanations on the use of the apparatus 1, it should be understood that the apparatus 401 can be used in various other configurations.

Beyond the specificities of the different embodiments which have been described hitherto for the different parts of the bodily mobilization apparatus 1, 301 and 401, it will be understood that these different embodiments can be combined with one another to give rise to new embodiments of body mobilization apparatus, functionally similar to the apparatuses 1, 301 and 401.

Finally, various advantageous optional arrangements can be envisaged for the body mobilization apparatus according to the invention. Examples include:
the stabilizing member of the apparatus, such as the stabilizing members 30, 130, 330 and 430, can be arranged so as to adapt to balls having different respective diameters; in other words, by means of ad hoc arrangements, the stabilizing member being advantageously adjustable to the size of the ball 10 or 410 actually used within the body mobilization apparatus, the adjustment being performed in particular before the actual use of the apparatus by the user; and/or
the frame of the apparatus, such as the frame 20 or 320 or 420, may be provided with fasteners for elastic bands designed to be tensioned by the user when using the apparatus as described hereinabove; in this way, the user U can work their upper limbs at the same time as the other parts of their body, mentioned hereinabove.

1. A body mobilization apparatus, comprising:
a frame resting fixedly on the ground;
a ball supporting the weight of a body part of a user when the body part is pressed on an upper portion of the ball while the user keeps at least one of his feet on the ground;
a stabilizing member, which is carried by said frame and which is designed to retain said ball by contact so as to keep a center of said ball substantially stationary with respect to said frame, while leaving said ball freely movable with respect to said frame at least in a first tilting movement about a first horizontal axis passing through the center of said ball; and
a movable support member, which is motorized and which supports a lower portion of said ball, pressed downwards against the movable support member under effect of pressing from the user on the upper portion of said ball, and to drive the lower portion of said ball at least in the first tilting movement with respect to said frame.

2. The body mobilization apparatus according to claim 1, wherein said ball has an overall spherical shape centered on the center, wherein said stabilizing member allows, while maintaining the center of said ball substantially stationary with respect to said frame, said ball to rotate freely about the center of said ball with respect to said frame, and wherein said movable support member drives the lower portion of said ball in rotation about the center of said ball with respect to said frame.

3. The body mobilization apparatus according to claim 2, wherein said movable support member drives the lower portion of said ball with respect to said frame exclusively in the first tilting movement.

4. The body mobilization apparatus according to claim 2, wherein said movable support member, in addition to driving the lower portion of said ball with respect to said frame in the first tilting movement, drives the lower portion of said ball with respect to said frame in a second tilting movement about a second horizontal axis, which passes through the center of said ball and is distinct from the first horizontal axis.

5. The body mobilization apparatus according to claim 4, wherein the second horizontal axis is perpendicular to the first horizontal axis.

6. The body mobilization apparatus according to claim 1, wherein said ball has an elongated shape, which extends lengthwise along the first horizontal axis and which, in cross-section perpendicular to the first horizontal axis, has a circular contour that is centered on the first horizontal axis.

7. The body mobilization apparatus according to claim 6, wherein the circular contour has a diameter which varies in value through said ball along the first horizontal axis, the diameter having a first value in a median portion of said ball and having a second value in each of two end portions of said ball, which are arranged on both sides of the median portion of said ball along the first horizontal axis, the first value being less than the second value.

8. The body mobilization apparatus according to claim 1, wherein said movable support member comprises:
a drive unit;
a stationary part that is rigidly attached to said frame; and
a movable part, on which the lower portion of said ball rests and which is mounted so as to be movable, on the stationary part and to be driven in motion by said drive unit.

9. The body mobilization apparatus according to claim 1, wherein in use, said stabilizing member is fixedly integrated into said frame and in sliding contact with the ball said ball.

10. The body mobilization apparatus according claim 1, wherein in use, said stabilizing member is freely movable with respect to said frame and is driven by contact by said ball.

11. The body mobilization apparatus according to claim 1, wherein said stabilizing member is arranged laterally to said ball and is in contact with an intermediate portion of said ball over a continuous zone of said stabilizing member, which, in projection in a horizontal plane, extends over more than 180° around said ball.

12. The body mobilization apparatus according to claim 1, wherein said stabilizing member (130) is arranged laterally to said ball and is in contact with an intermediate portion of said ball over a plurality of distinct zones of said stabilizing member, which, in projection in a horizontal plane, are dimensioned and distributed around said ball so as to maintain the center of said ball substantially stationary with respect to said frame.

13. The body mobilization apparatus according to claim 1 wherein said stabilizing member is arranged below and is in matching contact with the lower portion (10) of said ball.

14. The body mobilization apparatus according to claim 1, further comprising:
a control unit adapted to control in motion said movable support member; and
an interface activating and setting said control unit and displaying values relating to operation of the body mobilization apparatus.

15. The body mobilization apparatus according to claim 8 wherein said movable part is movable in translation or in rotation on said stationary part.

16. The body mobilization apparatus according to claim 11, wherein the intermediate portion of said ball extends, in projection in the horizontal plane, 360° around said ball.
